(19) United States
(12) Patent Application Publication
(10) Pub. No.: US 2013/0023343 A1
(43) Pub. Date: Jan. 24, 2013

(54) AUTOMATIC MUSIC SELECTION SYSTEM

(71) Applicant: Brian Schmidt, Bellevue, WA (US)

(72) Inventor: Brian Schmidt, Bellevue, WA (US)

(73) Assignee: BRIAN SCHMIDT STUDIOS, LLC, Bellevue, WA (US)

(21) Appl. No.: 13/550,391

(22) Filed: Jul. 16, 2012

Related U.S. Application Data
(60) Provisional application No. 61/509,782, filed on Jul. 20, 2011.

(51) Int. Cl. G06F 17/00; A63F 9/24

(52) U.S. Cl. 463/35; 700/94

(57) ABSTRACT

A music method includes; determining, using a processor, a status of the activity; translating, using the processor, the status into translated music descriptive data; obtaining, using the processor, a selected music piece based on the translated music descriptive data; and causing, using the processor, a music device to play the selected music piece during the activity.

### CROSS-REFERENCE TO RELATED APPLICATION

This application claims the benefit under 35 U.S.C. §119(e) of U.S. Provisional Patent Application No. 61/509,782, filed Jul. 20, 2012, which is incorporated herein by reference in its entirety.

### BACKGROUND

1. Technical Field

The present disclosure relates to automatic music selection systems.

2. Description of the Related Art

Video game systems, portable computing devices and other interactive media systems are increasingly being connected to and/or combined with traditional music and media playback systems.

Most videogames include custom written music specifically tailored to the game. Various pieces of music are written to match the various moods and game states within the game. Further it is well understood by those skilled in the art that music for a game or other such interactive media is not static, but is interactive, adjusting itself and changing in response to game actions. FIG. 1 shows how music may change depending on game state. For example, in an action game, there may be portions of the game which have very different levels of intensity. In one part of the game, there may be few if any enemies, while in another there may be many legions of enemies to be defeated. In a well designed game, the emotional intensity of the music is designed, through a series of creative and technical means, to follow the action presented to the player by the game in response to the player's or players' actions. Many game variables or game states may contribute to deciding, by way of example, the selection, tempo, emotional energy, density or other factors of the music. Additional examples include brief periods where a player is “invincible” or the player is near death. It is a common technique in video game scoring and composition to create specific pieces of music for those situations which may or may not play to completion, depending on the actions of the player. This not only ensures the background music helps reinforce the emotional state of the game, but also helps inform the player of their state within the game.

A challenging aspect of game design is known to be repetition. Because many video games are played for many hours, even the most skillfully composed music becomes annoying with repetition.

For these reasons some videogames and video game systems allow a game player to substitute the game provided music with their own music, directly from their own music collection (such as on Xbox 360 or Apple's iPod/iPhone) or some other source. However, such systems have many limitations. In current systems music selected by the player has little or no correlation to the actions and flow of the game itself. Certainly it would be possibly (and quite likely) for a user to select very high energy music from their own music library, but the game itself is in a low-energy state (such as the few to no enemy state previously described). This leads to a sub-optimal experience.

Overall, the examples herein of some prior or related systems and their associated limitations are intended to be illustrative and not exclusive. Other limitations of existing or prior systems will become apparent to those of skill in the art upon reading the present disclosure.

### BRIEF SUMMARY

One embodiment of the present disclosure overcomes the above problems, and provides additional benefits.

Described in detail herein is a music playback system which specifies when music which is accessible from a local or non-local music library with certain characteristics should be played in response to interactive media application actions or state such as in a video game or other computer application or device. Game or application states could, by way of example, include abstract variables such as player health, number of enemies to defeat, number of minutes played in the level, or parameters such as current real-world traffic congestion levels or number of times the brakes in an automobile have been applied in the past ten minutes. The music characteristics could be, by way of example, physical parameters (such as “high tempo” or “percussive”), emotional parameters (such as “stressful” or “triumphant”) and characterized by the use of musical or non-musical terms.

In an interactive media application, for example, a player can enjoy music from a wide variety of sources, such as their own music library, a streaming music service or other music library with their interactive media application and have the appropriate music selected to match action occurring within the game or state of a computing device. This is a significant advance over prior art systems.

The system described herein allows music other than that which is provided by the game developer to be played as substitute for any background music for the game, but still follow the emotional or other states of the game as it is being played. The system and method allow for selecting music from a collection based on parameters within a computing system in response to actual or virtual world actions and variables.

Videogames are not the only computing system within a media environment. Many devices such as portable music players, smartphone systems, navigation systems and other devices may also be connected with or able to access media environments such as a local or non-local music library.

### BRIEF DESCRIPTION OF THE SEVERAL VIEWS OF THE DRAWINGS

FIG. 1 shows an exemplary state diagram for an application with a corresponding list of songs to match the described game states.

FIG. 2 shows a computing system suitable for audio/visual presentation which is able to access a music library either locally or remotely, the music library consisting of a collections of songs (S1, S2, . . . , SN) which may or may not have associated descriptive data

FIG. 3 shows a block diagram one embodiment of the present system for automatic music selection

FIG. 4 shows a mapping of application state “Intensity” to a collection of songs' tempo descriptive data.

FIG. 5 shows a two dimensional mapping of application state to a collection of songs' descriptive data.

FIG. 6 shows an example mapping function of a real or virtual world parameter to limit music selection.

FIG. 7 shows a flowchart of a sequence of steps of one embodiment of the present disclosure.

FIG. 8 shows a flowchart of a sequence of steps of one embodiment of the present disclosure.

FIG. 9 shows a flowchart of a sequence of steps of one embodiment of the present disclosure.

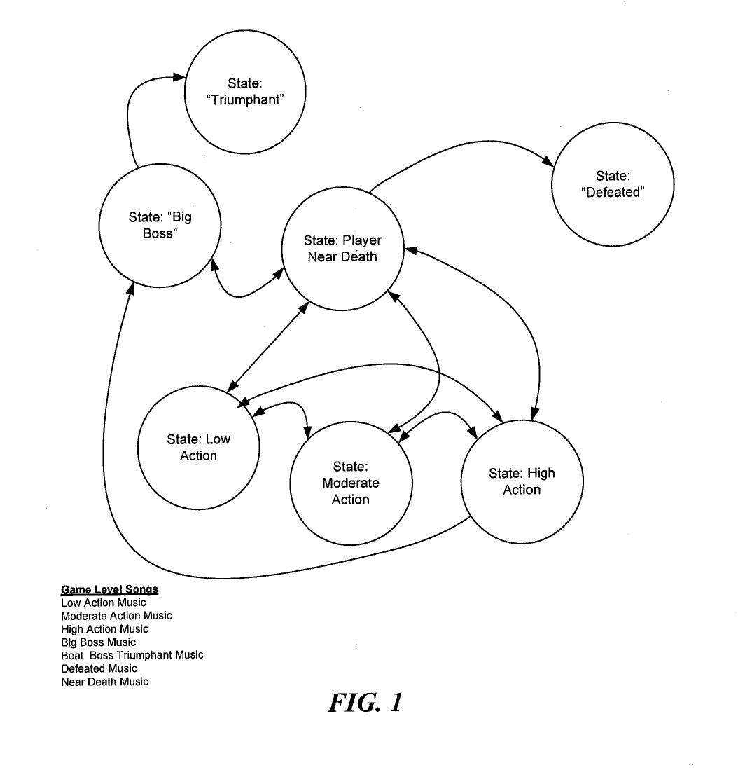

### DETAILED DESCRIPTION

Various examples of the invention will now be described. The following description provides certain specific details for a thorough understanding and enabling description of these examples. One skilled in the relevant technology will understand, however, that the invention may be practiced without many of these details. Likewise, one skilled in the relevant technology will also understand that the invention may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

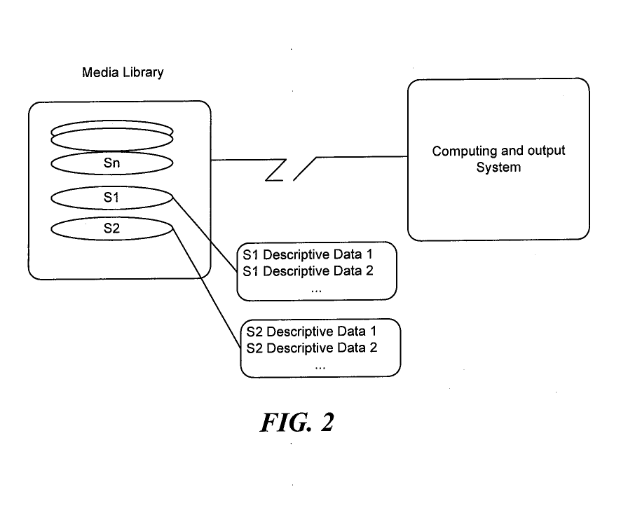

An improved music playback system is described herein. Referring to FIG. 2, there is shown a computer application or device which performs a function such as presenting a video game. Further, the application or device is connected to or has access to a media library. The media library is comprised of a collection of media files, by way of example a collection of music (S1, S2 . . . SN). “Media Library” refers to any collection of music, song or audio files. The media library files may be local (such as the case of an iPod, personal computer or game console) or may be remote, as in the case of a streaming internet radio station, local media library, local media server or some combination thereof. The music within the media library may be tagged with descriptive data with one or more categories of musical and/or non-musical description such as tempo, instrumental density, and/or emotional content by way of example. This descriptive data may be stored within the music, as metadata or may be stored at some other local or remote location. The descriptive data parameters may be binary (for example, “this music contains vocals”), may be continuous (for example, on a scale of 0-100, this song has a 75 rating on the “energetic” scale or a number of beats per minute) or may be an enumeration (this song is of genre “Smooth Jazz”). Some descriptive data may be measurable physical parameters such as tempo, while some descriptive data may be subjective in nature (such as how “tense” a piece of music sounds). Descriptive data may also be specifically tailored for gameplay, such as, by way of example only, “Exploring,” “enemy defeated,” “battle,” “near defeat,” “invincible” or others. Music may be pre-analyzed for descriptive data or may be analyzed on the fly. Certain types of descriptive data may also be created by a consensus of listeners. Descriptive data may also be set by an individual according to their own preferences. Further details regarding descriptive data are provided herein.

The computing system directs music playback according to the desired application state and/or variables. When the value of one or more of the applications variables changes in the course of operation, the music may also be changed. The decision as to whether or not to change background music and which piece of music should be selected is based on a mapping between the descriptive parameters of the music and the desired application states as well as other application information such as whether the application parameter has changed significantly enough to warrant a change in background music or of sufficient time has elapsed since the previous change in music.

In a simple implementation by way of example only, an application such as a video game at any given moment has a specific game variable “intensity” and desires to have the background music match the intensity of the game as the player progresses through the game. A game player has access to a collection of music which has been analyzed such that, by way of example only, the tempo of some, most or all songs is known and stored with the music as descriptive data. As the game progresses, if the game intensity is low, a slower tempo piece of music is selected from the player's music collection and played as background music for the game. As the game intensity increases, a new piece of music from the player's collection is chosen to replace the current music, perhaps prior to the completion of the current music, with the new music having a higher tempo. In this way, the tempo of the background music is correlated with the intensity of the game.

In another simple implementation a music system, such as in an automobile, may be created. Such a system could use a variety of variables, such as traffic congestion level (such as from a GPS unit), length of trip, average speed and number of times brakes applied to create a state variable traffic misery index within the system. When selecting appropriate music for playback, the traffic misery index may be mapped to specific tempo ranges, genres or other aspects of music to help ensure that heavy, grating music not be selected when the traffic misery is high.

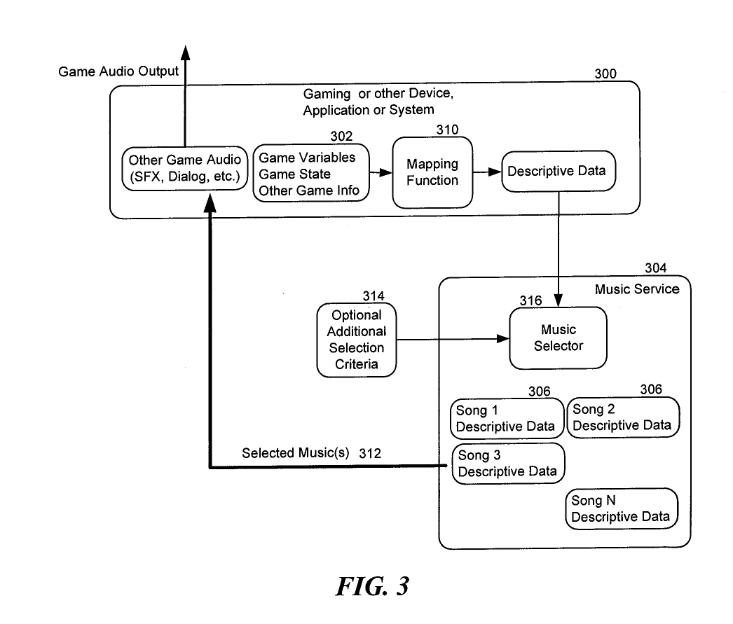

FIG. 3 shows how one embodiment of the present disclosure can be used to select appropriate music in an interactive application. A gaming or other device, application or system (300) maintains application variables and application state (302). The variables and/or state may change from time to time depending on user actions or may change values autonomously. To select appropriate music from a music library (304), the application variables and/or state are translated into descriptive data (306) by an optional mapping function (310), creating desired descriptive data. Once the desired descriptive data has been determined, appropriate music (312) from the music library (304) is selected. Note that many music libraries contain vast collections of music. The present system provides an additional mechanism for optionally specifying additional selection criteria (314) which are used by a music selector (316) to further determine music selection. It should be evident to those skilled in the art that the order, location or other details of FIG. 3 are not proscriptive and that processing blocks can occur equally within the gaming or other Device, application or system, within the music library or any other location not shown in FIG. 3. For example, it may be practical to specify initial additional selection criteria prior to performing descriptive data mapping.

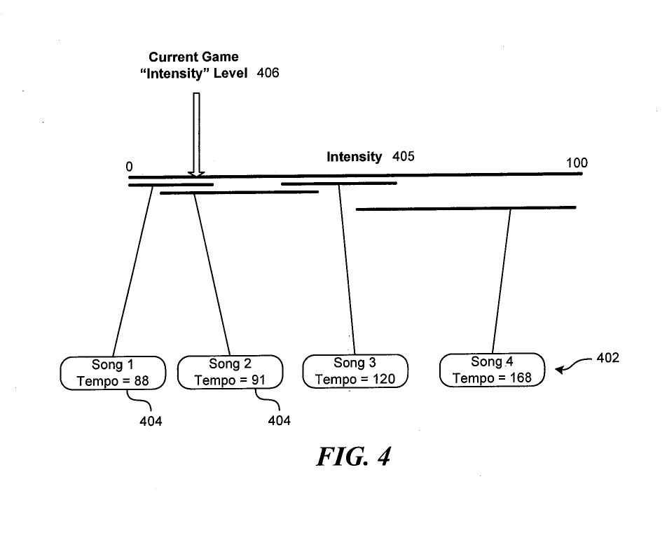

FIG. 4 shows an example of the present system with a music library comprising four songs (402), with tempo data (404) for each song. The game has a self-defined intensity value 405 which ranges from 0-100. Based on the current game intensity (406), the music is selected. Note that more than one piece of music may be suitable based on the game variable, intensity; in the FIG. 4, both Song 1 and Song 2 are appropriate for the current game intensity. In this event, the music may be chosen randomly between the two matching songs or based on some other criteria (such as artist, key signature, orchestration, genre or one or more other criteria, by way of example)

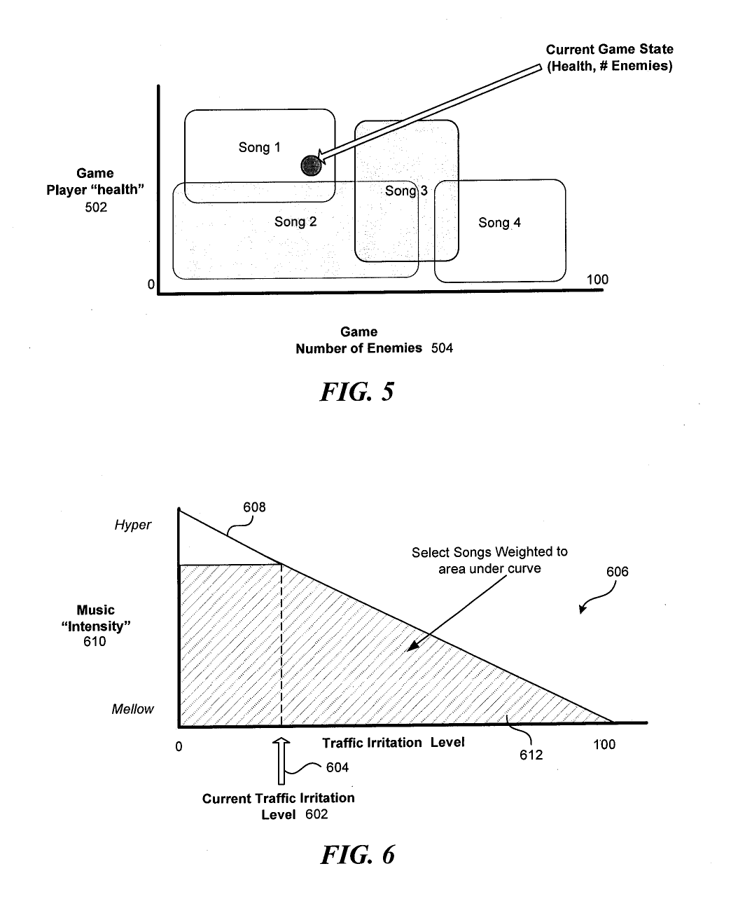

FIG. 4 shows a simple 1 to 1 mapping of game state (intensity) to a single music parameter (tempo). In general, an N to M mapping of the application state to descriptive data is possible, and in fact common. As shown in FIG. 5, two game variables, player health (502) and number of enemies (504) are used to select music for playback. It should be clear to those skilled in the art that any number, N, of game variables may be mapped to any number, M, of music descriptive data, and that there need not be a one to one correspondence between application variables and/or state and descriptive data.

FIG. 6 shows a different application of the system, namely the mapping and selection of a subset of music from a library for a given external condition such as a current traffic irritation level. In FIG. 6, the current traffic irritation level (602) may be determined by one or more external and/or internal application parameters such as, by way of example, current traffic congestion level, length of trip, average car velocity among others. Arrow (604) indicates the current traffic irritation level. The mapping is provided by Graph (606) and a line (608) specifying an area representing music selection. For a given traffic irritation level, a maximum music intensity (610) is determined by the mapping function. The shaded area (612) therefore represents the set of possible music with the proper Intensity for selection. Therefore, based on an application state, current traffic irritation level, a mapping as represented by graph (606), and a music collection with descriptive data including intensity (610), it is possible to determine a subset of music from which to select for playback at a given moment.

Returning to virtual applications such as video games, a game may also specify specific pieces of background music for specific game states. In this case, the system maps the music to the game states based on the values of one or more music descriptive data parameters. One such technique, by way of example only, is a table as shown below:

| | Tempo | Density | | |
|---|---|---|---|---|
| | Range | Range | | |
| Game State | (bpm) | (0-100) | Intensity | Description |
| Low Action | 0-90 | 0-50 | 0-30 | Any |
| Moderate Action | 70-100 | 0-50 | 0-50 | Any |
| High Action | 120-150 | 25-75 | 70-90 | Any |
| Big Boss | 150-200 | 60-90 | 90-100 | Any |
| Boss Beaten | Any | Any | Any | Triumphant |
| Player Defeated | Any | Any | Any | Sad |
| Near Death Music | Any | Any | 95-100 | tense |

In the event the current state of the game does not map to a specific piece of music, the game may use a number of algorithms to select appropriate music; by way of example, a song which is the closest match.

The advantages of the present system include, without limitation, that players can enjoy music from their own music collection while experiencing an application such as a video game, yet still have the background music follow the action of the game. Further, a player may be able to enjoy music from a vast collection of music, such as a streaming internet source and have the music selected by means of parameters influenced in whole or in part from aspects of the real world.

The game may specify a particular section of the game, along with parameters specific for that section. For example, during “battle” sequences the music selected may be limited to a subset of the entirety of the available music. The “intensity” during “battle” is then used to select appropriate music from among that subset.

The system may specify that only music within a particular genre is selected, upon preference by the user. For example, the user can specify he or she wants only “hard rock” to play as game background music, and the system will select music from the appropriate genre.

The music playback system may include hysteresis, requiring the desired game state be changed for some period of time or exceed a threshold by some amount before changing or altering the music.

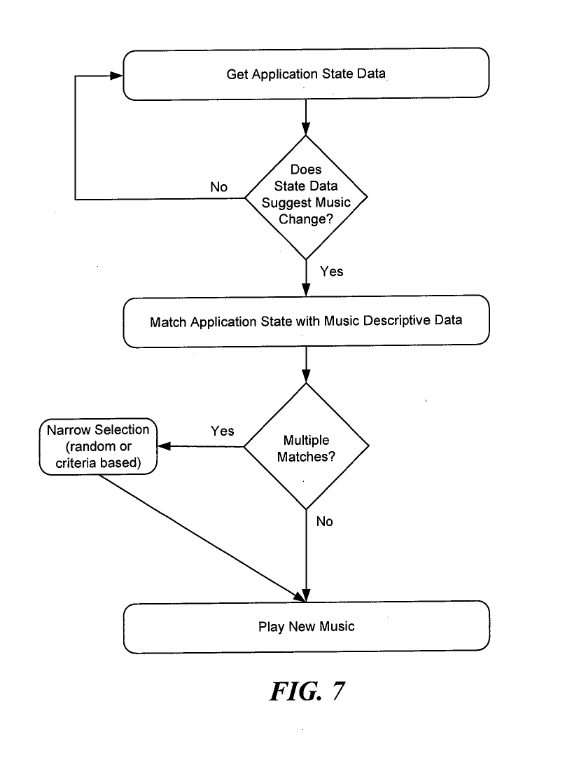

Further details regarding operations of a method according to one embodiment of the present disclosure are shown in the flow diagram of FIG. 7. The method starts by obtaining the application state data (step 700) from an application such as a video game application. In step 702, the method determines whether the application state data suggest a music change. If not, then the method returns to step 700 to obtain new application state data. This loop of steps 700 and 702 can be performed continuously, at set intervals, randomly, or in any other timely manner. If step 702 determines that application state data suggest a music change, the method goes to step 704 in which the method matches the application state with descriptive data of a set of music pieces. In step 706, the method determines whether there is more than one music piece having descriptive data that matches the application state. If so, then the method performs step 708 by narrowing the music pieces down to one selected music piece. As indicated in FIG. 7, the narrowing may be done randomly or based on some narrowing criteria such as how closely the descriptive data of each music piece matches the application state, how recently each matching music piece has been played, etc. Lastly, the method plays the selected music piece in step 710. If step 706 determines that the descriptive data of only one music piece matches the application state, then the method goes directly to step 710 to play the selected music piece immediately or to queue the music piece to be played at some later time.

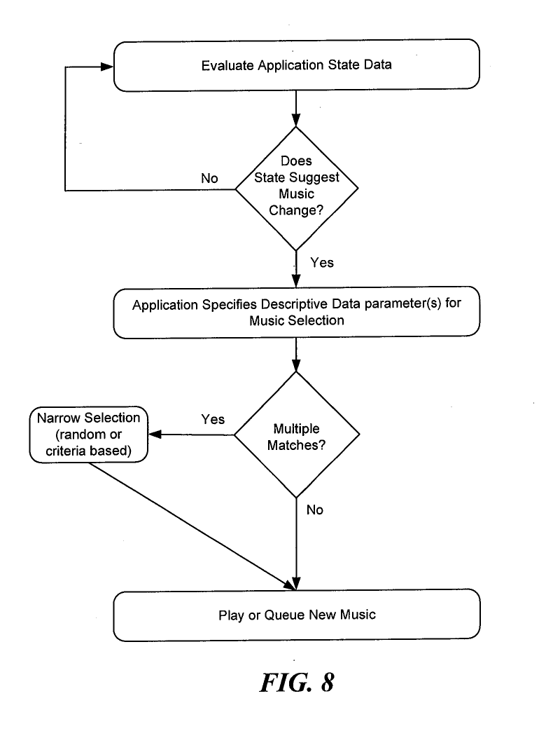

A method according to another embodiment of the present disclosure is shown in the flow diagram of FIG. 8. The method starts by evaluating the application state data (step 800) from an application such as a video game application. In step 802, the method determines whether the application state data suggest a music change. If not, then the method returns to step 800 to evaluate new application state data. This loop of steps 800 and 802 can be performed continuously, at set intervals, randomly, or in any other timely manner. If step 802 determines that application state data suggest a music change, the method goes to step 804 in which the method receives from the application descriptive data for selecting a new music piece. In step 806, the method determines whether there is more than one music piece having descriptive data that matches the application state. If so, then the method performs step 808 by narrowing the music pieces down to one selected music piece. As indicated in FIG. 8, the narrowing may be done randomly or based on some narrowing criteria such as how closely the descriptive data of each music piece matches the application state, how recently each matching music piece has been played, etc. Lastly, the method plays the selected music piece in step 810. If step 806 determines that the descriptive data of only one music piece matches the application state, then the method goes directly to step 810 to play the selected music piece immediately or to queue the music piece to be played at some later time.

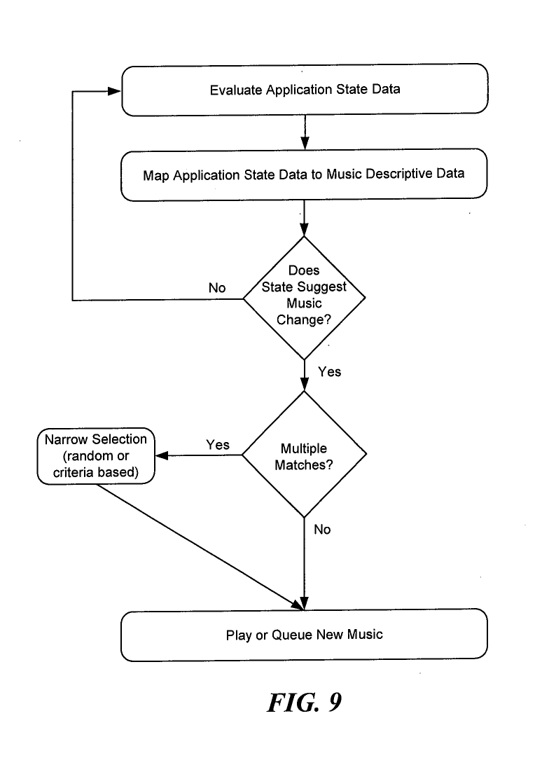

A method according to another embodiment of the present disclosure is shown in the flow diagram of FIG. 9. The method starts by evaluating the application state data (step 900) from an application such as a video game application. In step 902, the method maps the application state data to music descriptive data. In step 904, the method determines whether the application state suggests a music change. If not, then the method returns to step 900 to evaluate new application state data. This loop of steps 900-904 can be performed continuously, at set intervals, randomly, or in any other timely manner. If step 904 determines that application state suggests a music change, the method goes to step 906 in which the method determines whether there is more than one music piece having descriptive data that matches the application state. If so, then the method performs step 908 by narrowing the music pieces down to one selected music piece. As indicated in FIG. 9, the narrowing may be done randomly or based on some narrowing criteria such as how closely the descriptive data of each music piece matches the application state, how recently each matching music piece has been played, etc. Lastly, the method plays the selected music piece in step 910. If step 906 determines that the descriptive data of only one music piece matches the application state, then the method goes directly to step 910 to play the selected music piece immediately or to queue the music piece to be played at some later time.

In one embodiment, prior to playing the selected music piece, the method determines a time at which an original music piece of the music provided with the video game application was designed to play. The method causes the music device to play the selected music piece at a time based on the time at which the original music piece was designed to play.

Although the illustrated methods in FIGS. 7-9 each show a specific order of executing functional logical blocks, the order of execution of the blocks may be changed relative to the order shown. Also, two or more blocks shown in succession may be executed concurrently or with partial concurrency. Certain blocks may also be omitted. In addition, any number of commands, state variables, semaphores or messages may be added to the logical flow for purposes of enhanced utility, accounting, performance, measurement, troubleshooting and the like. It is understood that all such variations are within the scope of the present invention.

The system may be enhanced by one or more of the aspects, such as the following features.

If more than one song in the library meets the playback criteria, one from multiple of songs may be selected by a collision function. The collision function may select the song at random, or according to some heuristic, for example preference given to the same artist (or preference being given to a different artist), similar orchestration, musical Key or other musical or non-musical parameters.

By way of example, simple techniques such as crossfading the current music to the new music, or sophisticated techniques such as beat-matched transitioning can occur.

The system may map music data to gameplay data, or the game may elect to specify music parameters directly. For example, the game may specify that music to be played should be of a certain tempo range, with a certain density of instrumentation or of a certain level of “excitedness.”

The aspects of the current song (such as tempo, orchestration, key or other parameters) may be used in part or whole to determine the next song (to match the current game state).

The system may also incorporate user tastes and preferences when selecting game appropriate background music, such as, by way of example and without limitation, giving preference to music recently listened to.

Background music may be downloaded to local storage, streamed from a local or remote server, or otherwise be provided to the application and/or device.

A set of songs can be marked as belonging to a specific song group. This will give preference or exclusivity to these songs during a game session. This allows a composer or band to create a soundtrack consisting of a complete set of music for a particular game, and have it replace the games existing soundtrack.

The music replacement system may be used for the entirety of gameplay, or only for certain sections. For example, a games “menu music” may be unchanged, but the “battle music” may be selected according to the system.

The system may analyze the music provided with a game to determine various characteristics about the music, and select suitable replacement songs which are “most like” the original. The analysis may be done by machine or human analysis. For example, the music for a specific game title can be listed and categorized according to specific musical or non-musical criteria. The system could then create an alternate soundtrack using the analyzed criteria as a guideline for creating the new soundtrack.

The above system may also additionally narrow music selection by genre, artist, year or any number of one or more criteria of the music.

Descriptive data may be created by players and uploaded for use by other players.

Descriptive data may specify a particular game or application as preferred usage.

Descriptive data may specify a particular genre or style of game, such as “racing,” “puzzle,” “shooter,” or other broad descriptive.

A single piece of music may have multiple sets of descriptive data, depending on the time index of the music. The system may consider sections of music to be valid entry points. For example, if after a quiet introduction, the music gets very intense, the system can begin playback at the intense section if intense music is called for.

The system may play new music immediately, after some minimum time interval, at a musically opportune moment, such as the end of a musical measure, beat or phrase, or after completion of the current music or combination thereof.

The system may utilize a mechanism for determining the proper volume for newly selected music in whole or in part, based on an analysis (in real-time and/or performed offline) of the volume and/or frequency content of the game-supplied music, such volume and frequency known to vary throughout the music.

The system may provide for a mechanism for processing, using digital signal processing (DSP) techniques the playing music in response to game actions. As one such example, the frequency and/or volume of the music may be altered during a game's dialog, so that the dialog may be heard more clearly over the music.

The system may use information in an existing application to determine whether to play back music or not, such as, by way of example only, by the use of game API's, or by the analysis of the game's existing music.

If the music is located at a remote location, such as a streaming music service or remote music library, the game data may be translated into music descriptive data at the game console, sending only desired descriptive data to the music service or music library.

The system may analyze the game provided music in real time (such as, by way of example, using beat detection algorithms) to determine parameters for selecting new, alternate music tracks.

Portions of the functionality may be performed by the presenting device (video game unit, GPS unit, PC and so on) or by an external device such as a media store.

Music selection may be used to reflect player actions, lead player actions or induce the player to non-game related actions such as purchasing virtual or actual goods based game state, much in the way Muzak™ is used in department stores to subtly influence purchasing decisions. In one such example, as the player approaches a difficult portion of the game where having a particular virtual item can help them through the game, the music may be selected to increase the odds of the virtual item purchase.

The computing system or application may access the descriptive data to select appropriate music, or the music library may access the state of the computing system or application to select appropriate music.

Determination of the music state of the game may be inferred by monitoring the game input device(s). For example, based on the frequency of button presses or joystick movements, an “intensity” parameter used to select more or less intense music could be utilized. Similarly, greater frequency or amplitude in body motions (when using a motion-based game input device such as Nintendo's Wii Remote, Microsoft's Kinect or Sony's Move or accelerometer in iPhone or other handheld device) may result in different music selections being chosen.

In general, described herein is a method and system for automatically selecting and/or playing music from a music library for use with interactive applications or other environments and in such as way as to have the character of the music match desired characteristics, state or action occurring in the application. The appropriate music is selected at appropriate times in a way such that music selection and playback from a music library is done in a way as to match states or actions of the application.

While known to those skilled in the art, a brief, general description of a suitable computing environment in which the invention can be implemented will be provided for those not necessarily skilled in the art. Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), tablets, wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” and the like are generally used interchangeably herein, and refer to any of the above devices and systems, as well as any data processor.

A computer implementing aspects of the invention may have one or more processors coupled to one or more user input devices and data storage devices. The computer is also coupled to at least one output device such as a display device and one or more optional additional output devices (e.g., printer, plotter, speakers, tactile or olfactory output devices, etc.). The computer may be coupled to external computers, such as via an optional network connection, a wireless transceiver, or both.

The input devices may include a game controller, keyboard and/or a pointing device such as a mouse. Other input devices are possible such as a microphone, joystick, pen, scanner, digital camera, video camera, and the like. The data storage devices may include any type of computer-readable media that can store data accessible by the computer, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A music method, comprising:
determining, using a processor, a status of an activity;
translating, using the processor, the status into translated music descriptive data;
obtaining, using the processor, a selected music piece based on the translated music descriptive data; and
causing, using the processor, a music device to play the selected music piece during the activity.

2. The method of claim 1, wherein the activity includes a user playing a video game and the determining includes determining the status of the video game.

3. The method of claim 2, further comprising executing a video game application using the processor, wherein the translating includes executing translating instructions of the video game application that cause the processor to translate the status into the translated music descriptive data.

4. The method of claim 2, further comprising:
executing a video game application using the processor, wherein executing the video game application enables the user to play the video game;
analyzing music provided with the video game application; and
selecting a list of alternative music using as guidelines the music provided with the video game application, wherein obtaining the selected music piece includes selecting the selected music piece from the list of alternative music.

5. The method of claim 4, further comprising selecting musical playback information, including volume, for the selected music piece based on corresponding musical playback information for the music provided with the video game application.

6. The method of claim 4, further comprising:
determining a time at which an original music piece of the music provided with the video game application was designed to play, wherein causing the music device to play the selected music piece includes causing the music device to play the selected music piece at a time based on the time at which the original music piece was designed to play.

7. The method of claim 2, further comprising:
associating with a stored music piece an indication that a particular game or application is a preferred usage for the stored music piece, wherein obtaining the selected music piece includes considering the indication when selecting the selected music piece to be played by the music device.

8. The method of claim 2, wherein determining the status of the video game includes monitoring inputs produced by one or more game input devices in response to actions of the user.

9. The method of claim 1, wherein the obtaining includes selecting the selected music piece based in part on musical parameters of the first music piece and based in part on the translated music descriptive data.

10. The method of claim 1, further comprising performing a hysteresis step that:
determining whether a change threshold has been satisfied, wherein determining whether the change threshold has been satisfied includes at least one of:
determining whether the status has been changed for a threshold period of time; and
determining whether the status has changed by a threshold amount; and
delaying the causing until determining that the change threshold has been satisfied.

11. The method of claim 1, wherein the obtaining includes:
requesting the selected music piece from a streaming audio content provider; and
receiving the selected music piece from the streaming audio content provider.

12. The method of claim 1, wherein the obtaining includes reading the selected music piece from a storage device coupled to the processor.

13. The method of claim 1, further comprising detecting the status of the activity using a status detection device coupled to the processor, wherein the determining includes receiving from the status detection device information regarding the status of the activity.

14. The method of claim 1, wherein the obtaining includes:
sending the translated music descriptive data to a streaming audio content provider and requesting the streaming audio content provider to select a music piece corresponding to the music descriptive data; and
receiving the selected music piece in streamed format from the streaming audio content provider.

15. The method of claim 1, further comprising receiving, from a user, music descriptive data for each of a plurality of music pieces, including the selected music piece, being stored on a storage device coupled to the processor, wherein the obtaining includes determining that the music descriptive data for the selected music piece corresponds to the translated music descriptive data.

16. A non-transitory computer readable medium storing instructions, which when operated by a processor, performs a method comprising:
determining, using the processor, a status of the activity;
translating, using the processor, the status into translated music descriptive data;
obtaining, using the processor, a selected music piece based on the translated music descriptive data; and
causing, using the processor, a music device to play the selected music piece during the activity.

17. The computer readable medium of claim 16, wherein the activity includes a user playing a video game and the determining includes determining the status of the video game.

18. The computer readable medium of claim 16, wherein the obtaining includes:
requesting the selected music piece from a streaming audio content provider; and
receiving the selected music piece from the streaming audio content provider.

19. The computer readable medium of claim 16, wherein the obtaining includes reading the selected music piece from a storage device coupled to the processor.

20. The computer readable medium of claim 16, further comprising detecting the status of the activity using a status detection device coupled to the processor, wherein the determining includes receiving from the status detection device the information regarding the status of the activity.

21. The computer readable medium of claim 16, wherein the obtaining includes:
sending the translated music descriptive data to a streaming audio content provider and requesting the streaming audio content provider to select a music piece corresponding to the music descriptive data; and
receiving the selected music piece in streamed format from the streaming audio content provider.

22. The computer readable medium of claim 16, further comprising receiving from a user music descriptive data for each of a plurality of music pieces, including the selected music piece, being stored on a storage device coupled to the processor, wherein the obtaining includes determining that the music descriptive data for the selected music piece corresponds to the translated music descriptive data.

23. An interactive music system, comprising:
a music device configured to play music; and
a processor coupled to the music device and configured to:
determine a status of the activity;
translate the status into translated music descriptive data;
obtain a selected music piece based on the translated music descriptive data; and
cause a music device to play the selected music piece during the activity.

24. The system of claim 23, wherein the activity includes a user playing a video game and the processor is configured to determine the status of the video game.

25. The system of claim 23, wherein the processor is configured to obtain the selected music piece by:
requesting the selected music piece from a streaming audio content provider; and
receiving the selected music piece from the streaming audio content provider.

26. The system of claim 23, wherein the processor is configured to obtain the selected music piece by reading the selected music piece from a storage device coupled to the processor.

27. The system of claim 23, further comprising a status detection device coupled to the processor and configured to detect the status of the activity and send to the processor information regarding the status of the activity.

28. The system of claim 23, wherein the processor is configured to obtain the selected music piece by:
sending the translated music descriptive data to a streaming audio content provider and requesting the streaming audio content provider to select a music piece corresponding to the music descriptive data; and
receiving the selected music piece in streamed format from the streaming audio content provider.

29. The system of claim 23, further comprising a storage device coupled to the processor and configured to store music pieces, wherein the processor is configured to:
receive, from a user, music descriptive data for each of a plurality of music pieces, including the selected music piece, being stored on the storage device; and
obtain the selected music piece by determining that the music descriptive data for the selected music piece corresponds to the translated music descriptive data.
